(19) United States
(12) Patent Application Publication
(10) Pub. No.: US 2013/0271461 A1
(43) Pub. Date: Oct. 17, 2013

(54) SYSTEMS AND METHODS FOR OBTAINING PARAMETERS FOR A THREE DIMENSIONAL MODEL FROM REFLECTANCE DATA

(71) Applicant: PINPOINT 3D, Holladay, UT (US)

(72) Inventor: Brandon J. Baker, Salt Lake City, UT (US)

(73) Assignee: PINPOINT 3D, Holladay, UT (US)

(21) Appl. No.: 13/836,132

(22) Filed: Mar. 15, 2013

Related U.S. Application Data
(60) Provisional application No. 61/729,764, filed on Nov. 26, 2012.
(60) Provisional application No. 61/725,059, filed on Nov. 12, 2012.
(60) Provisional application No. 61/622,646, filed on Apr. 11, 2012.

(51) Int. Cl. G06T 17/00

(52) U.S. Cl. CPC G06T 17/00
USPC 345/420

(57) ABSTRACT

In one example, a method of generating a 3D electronic model of one or more physical objects includes obtaining reflectance data associated with a physical object, obtaining key features from within the reflectance data, utilizing the key features to obtain a model parameter or plurality of model parameters, and estimating the value of a model parameter or plurality of model parameters that characterize a 3D electronic model of the physical object.

### RELATED APPLICATIONS

This application is related, and claims priority, to the following patent applications: U.S. Provisional Patent Application Ser. 61/729,764, entitled SYSTEMS AND METHODS FOR CREATING AN ARCHITECTURAL 3D MODEL, and filed Nov. 26, 2012; U.S. Provisional Patent Application Ser. 61/725,059, entitled SYSTEMS AND METHODS FOR ESTIMATING A PARAMETER OF A 3D MODEL, and filed Nov. 12, 2012; and, U.S. Provisional Patent Application Ser. 61/622,646, entitled SYSTEMS AND METHODS FOR ESTIMATING A PARAMETER OF A 3D MODEL, and filed Apr. 11, 2012. All of the aforementioned applications are incorporated herein in their respective entireties by this reference.

This application is also related to U.S. patent application Ser. No. 12/482,327, entitled SYSTEMS AND METHODS FOR ESTIMATING A PARAMETER FOR A 3D MODEL, filed Jun. 10, 2009, and incorporated herein in its entirety by this reference.

### FIELD OF THE INVENTION

Embodiments of the present invention generally concern the development of a three dimensional model based on data gathered concerning one or more physical objects. More particularly, some embodiments of the invention concern systems and methods for developing a three dimensional model using reflectance data associated with one or more physical objects.

### BACKGROUND

As-built models of industrial plants are utilized extensively in asset management, asset virtualization, risk assessment, and emergency evacuation planning and training. Ascertaining as-built information usually involves taking measurements, utilizing those measurements to create geometric primitives, annotating the primitives with descriptive information, and storing the results in a database for future use. Geometric primitives can be created from photogrammetric methods, although extracting them from light detecting and ranging (LIDAR) data is more prevalent. Photorealistic attributes of geometric primitives are utilized much more scarcely in industry today. In fact, few computer-aided design (CAD) visualization and utilization tools available today are even capable of properly rendering the diffuse and specular material properties of 3D CAD models. Even if rendering material properties is not currently widespread, few, if any, CAD tools can even extract photorealistic material data effectively or efficiently.

Diffuse and specular material properties, such as specular reflectance, have a wide variety of uses in CAD systems. Some examples include material property identification for model annotation, visual referencing, risk assessment, emergency evacuation response training, automated object recognition, and marketing demonstrations.

With the continual advancements in graphics rendering systems, reflectance models have more value today than ever before. However, the current state of the art in obtaining a 3D model from reflectance data lacks the robustness and completeness that the industry requires for a viable solution. 3D data points may be obtained from reflectance data, but this does not comprise a complete 3D model. Furthermore, the current state of the art lacks a solution that refines data while enhancing visual quality, maintaining or improving physical accuracy, or reducing data size effectively. Finally, the current state of the art lacks a robust method for applying reflective image information to such a 3D model that has been adequately processed from reflectance data.

### BRIEF DESCRIPTION OF THE DRAWINGS

The appended drawings contain figures of example embodiments to further illustrate and clarify various aspects of the present invention. It will be appreciated that these drawings depict only example embodiments of the invention and are not intended to limit its scope in any way. Aspects of the invention will be described and explained with additional specificity and detail through the use of the accompanying drawings in which:

FIG. 1 is a representation of received reflectance data;

FIG. 2 is a representation of another set of reflectance data, possessing a different set of acquisition parameters;

FIG. 3 is an illustration of the identified key features within a set of reflectance data;

FIG. 4 is another illustration of the identified key features within a set of reflectance data, possessing a different set of acquisition parameters;

FIG. 5 is a representation of a set of reflectance data from which key features have been connected;

FIG. 6 illustrates the utilization of library objects to determine the orientation and position of objects in a set of reflectance data;

FIG. 7 illustrates the utilization of a library object as a target with a bit-encrypted code;

FIG. 8 illustrates a matrix bar code that may be used as a library object in the present invention;

FIG. 9 illustrates another matrix bar code that may be used as a library object in the present invention;

FIG. 10 illustrates a checker pattern and a linear bar code that may be used as a library object in the present invention;

FIG. 11 illustrates a checker pattern and a pseudo noise encrypted code that may be used as a library object in the present invention;

FIG. 12 illustrates reflectance data with key features that may be identified as targets;

FIG. 13 illustrates an exemplary embodiment of a reflectance data acquisition device that may also contain an angular sensing device;

FIG. 14 illustrates a reflectance data acquisition device with an angular sensing device with the key feature of an intersection of two walls and a floor centered for identification;

FIG. 15 illustrates a reflectance data acquisition device with an angular sensing device with the key feature of an intersection of two walls and a ceiling centered for identification;

FIG. 16 illustrates a reflectance data acquisition device with an angular sensing device with the key feature of the lower left corner of a door centered for identification;

FIG. 17 illustrates a reflectance data acquisition device with an angular sensing device with the key feature of the upper left corner of a door centered for identification;

FIG. 18 illustrates a reflectance data acquisition device with an angular sensing device with the key feature of the upper right corner of a door centered for identification;

FIG. 19 illustrates a reflectance data acquisition device with an angular sensing device with the key feature of the lower right corner of a door centered for identification;

FIG. 20 illustrates a reflectance data acquisition device with an angular sensing device with the key feature of the upper left corner of a window centered for identification;

FIG. 21 illustrates a reflectance data acquisition device with an angular sensing device with the key feature of the lower left corner of a window centered for identification;

FIG. 22 illustrates a reflectance data acquisition device with an angular sensing device with the key feature of the lower right corner of a window centered for identification;

FIG. 23 illustrates a reflectance data acquisition device with an angular sensing device with the key feature of the upper right corner of a window centered for identification;

FIG. 24 illustrates a reflectance data acquisition device with an angular sensing device with two distinct models that may be conjoined;

FIG. 25 illustrates a reflectance data acquisition device with an angular sensing device with two distinct models close together;

FIG. 26 illustrates a reflectance data acquisition device with an angular sensing device with two distinct models that have been conjoined;

FIG. 27 illustrates the geometry associated with determining parameters for a 3 dimensional model using a reflectance data acquisition device and an angular sensing device;

FIG. 28 illustrates the geometry associated with determining parameters for a 3 dimensional model using a reflectance data acquisition device and an angular sensing device;

FIG. 29 illustrates the geometry associated with determining parameters for a 3 dimensional model using a reflectance data acquisition device and an angular sensing device;

FIG. 30 illustrates the geometry associated with determining parameters for a 3 dimensional model using a reflectance data acquisition device and an angular sensing device;

FIG. 31 is a flow chart indicating aspects of one example method; and

FIG. 32 is a schematic of an example operating environment for at least some embodiments of the invention.

### DETAILED DESCRIPTION OF SOME EXAMPLE EMBODIMENTS

Embodiments of the present invention generally concern the development of a three dimensional model based on data gathered concerning one or more physical objects. Such data may relate to one or more optical features or properties of the physical objects. Thus, some particular embodiments of the invention concern systems and methods for developing a three dimensional model using reflectance data associated with one or more physical objects.

At least some example embodiments of the present invention create a 3D model from reflectance data obtained in connection with one or more physical objects. In some examples, the 3D model is created by obtaining physical object parameters such as 3D spatial data, surface topology, edge geometry, texture mapping, texture mapping coordinates, object color, specular or diffuse reflectance parameters, annotation information such as object type (examples include, but are not limited to, architectural features such as window, floor, ceiling, wall, and door) or material type (examples include, but are not limited to, wood, metal, plastic, painted surface, and tile) and/or other parameters from reflectance data. The parameters are then used to generate a 3D computer model of the physical object(s) to which the parameter(s) relate, as discussed in more detail below. In general, any combination of the aforementioned parameters, and/or other parameters disclosed herein, can be gathered in association with one or more physical objects, and used to generate one or more 3D models of the object(s).

The model created may be an architectural model, but that is not required. Architectural features may include, without limitation, a wall/floor intersection, a ceiling/wall intersection, the outline of a door, the outline of a window, an angled ceiling, a boxed ceiling to hide duct work or other, a closet, a shelf or other opening indented in a wall, a kitchen island, cabinetry, and a countertop.

Reflectance data may include digital imagery acquired from a variety of systems and methods including, but not limited to a multi-spectral imaging device, digital image camera, and digital video camera.

In one example embodiment, a method includes using computer graphics rendering techniques to obtain parameters relating to a 3D model from a plurality of sets of reflectance data. Such parameters that are obtained may include, without limitation, surface topology, edge geometry, luminous or reflective characteristics, texture maps, visual properties, physical properties or other annotation information that may be present in a Building Information Model (BIM). Photorealistic 3D models of existing conditions for industrial plants are highly valuable in today's electronic age. For example, such photorealistic information could be utilized to ascertain material properties to automatically create intelligent CAD databases.

Example embodiments of the present invention may utilize a target or plurality of targets to resolve 3D spatial data. Likewise, example embodiments of the present invention may utilize target data to determine object type or material type. The target may be, for example: a physical item placed in a scene prior to acquiring reflectance data; a user identified mark corresponding to a portion of the reflectance data; and/or, a distinguishable portion of the acquired reflectance data.

The reflectance data may comprise more than a plurality of data sets pertaining to one object or scene, or a single acquisition. A plurality of reflectance data points may be simultaneously acquired by a sensor array, or a single datum may be acquired at a time. Targets may be encoded with attributes that are detectable in the reflectance data, or may be assigned by a user at the time of identification. 3D spatial information may be obtained by utilizing known optical characteristics of the reflectance data acquisition device, or those optical characteristics may be determined from the reflectance data. 3D spatial information may be obtained by utilizing an angular sensing device in conjunction with the reflectance data acquisition device. A target may be a key feature found in the reflectance data. With reference now to the Figures, details are provided concerning various example embodiments.

A. Gathering and Using Parameters to Generate 3D Models

Reflectance data may comprise digital image information concerning one or more physical objects, where the digital image information may be obtained from sources such as a digital camera or other reflective data sensing device. Digital image information may be represented in the form of an image or a video, or a combination of the two.

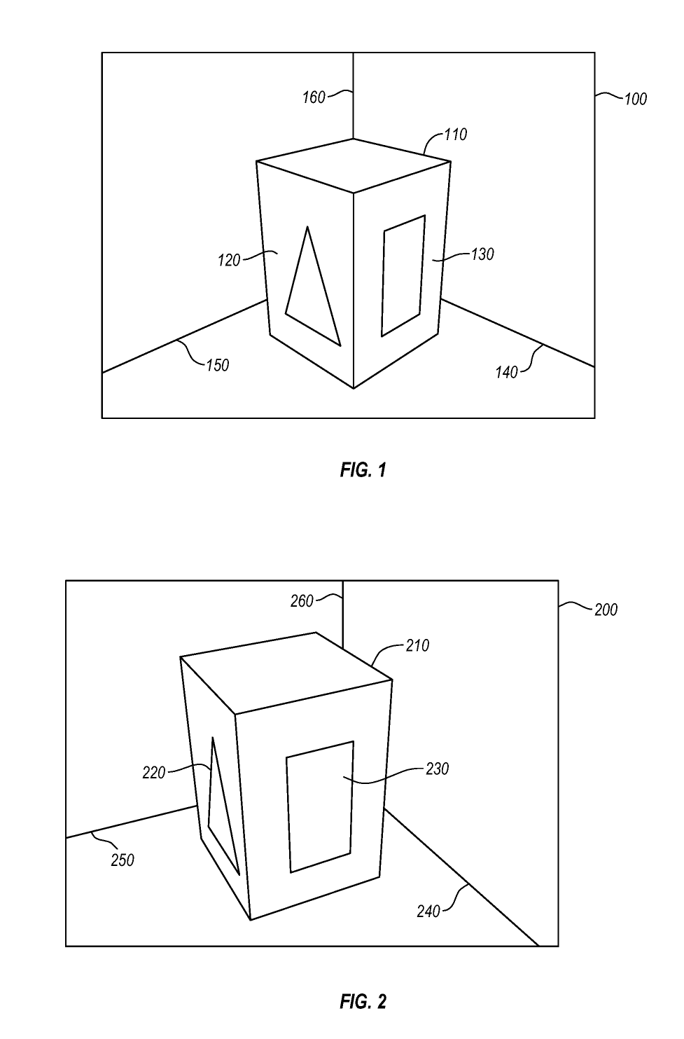

FIG. 1 shows an illustration of an example set of reflectance data (100). Within the set of data, there is a box (110), an image of a triangle (120) on the left side of the box, a rectangle (130) on the right side of the box, a line (140) where a supporting object, such as a floor or table or other, meets a left facing wall, a line (150) where the supporting object meets a right facing wall, and a line (160) where the left facing wall meets the right facing wall. FIG. 2 shows an illustration of a different set of reflectance data (200) that were acquired with a different set of acquisition parameters. Within this second set of data, there is a box (210), an image of a triangle (220) on the left side of the box, a rectangle (230) on the right side of the box, a line (240) where a supporting object, such as a floor or table or other, meets a left facing wall, a line (250) where the supporting object meets a right facing wall, and a line (260) where the left facing wall meets the right facing wall.

In connection with the gathering of data, such as reflectance data for example, suitable for use in generation of a 3D model, it may be useful to gather data concerning one or more ‘key features’ of one or more physical objects. It should be noted that the use of the term ‘key features’ is not intended to limit the scope of the invention in any way, but is used simply to acknowledge that, for certain embodiments, some features may be of particular interest. The key features may be obtained by methods that include any image processing technique, without limitation: edge detection, line detection, feature detection, circle detection, or corner detection. The line where a floor and wall intersect, for example, may be obtained hereby. Similarly, the line where a wall and a ceiling intersect may be obtained using an image processing technique. Such key features in architecture, for example, may correspond directly to artifacts readily detected using image processing methods. Feature detection may be accomplished by utilizing, for example, the Hough Transform, Sobel, Canny, Prewit edge detection, Mexican hat filtering, or Gaussian filtering. The person of ordinary skill in the art will appreciate that other techniques may also be employed.

Key features may be utilized, along with a non-rigid registration technique, to map a plurality of points or features from one data set to another. Furthermore, a non-rigid registration technique may be utilized to relate common features from a plurality of data sets. Identifying similar features may employ a non-rigid registration technique. Non-rigid registration may be accomplished by b-spline grid mapping, mutual information metric, or chi-squared metric. The person of ordinary skill in the art will appreciate that other techniques may also be employed.

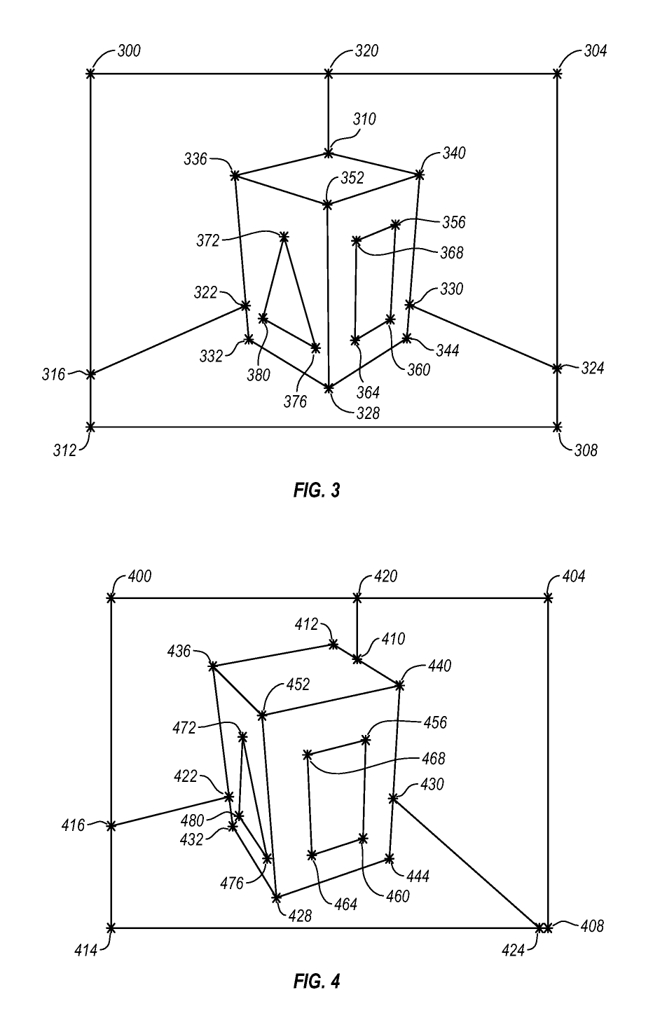

FIG. 3 illustrates the example key features that were identified in the data set 100 from FIG. 1. The key features identified include: the upper left corner of the data set (300); the upper right corner (304), the lower right corner (308); the lower left corner (312); the line (316) of intersection of 150 and the left side of 100; the point (320) of intersection of 160 and the top of 100; the point (324) of intersection of 140 and the right side of 100; the point (310) of intersection of the top corner of 110 and the wall 160; the point (330) of intersection of 140 and 110; the point (322) of intersection of 150 and 110; the upper right corner (340) of 110; the lower right corner (344) of 110; the lower left corner (332) of 110; the upper left corner (336) of 110; the center corner (328) of 110, the lower left corner (332) of 110; the upper center corner (352) of 110; the top (327) of triangle 120; the lower left base (380) of triangle 120; the lower right base (376) of triangle 120; the upper right corner (356) of rectangle 130; the lower right corner (360) of rectangle 130; the lower left corner (364) of rectangle 130; and the upper left corner (368) of rectangle 130.

Likewise, FIG. 4 illustrates the example key features that were identified in the data set 200 from FIG. 2. The key features identified include: the upper left corner of the data set (400); the upper right corner (404), the lower right corner (408); the lower left corner (412); the line (416) of intersection of 250 and the left side of 200; the point (320) of intersection of 260 and the top of 200; the point (424) of intersection of 240 and the right side of 200; the point (410) of intersection of the box 210 and the wall 260; the upper middle corner (412) of the box 210; the point (430) of intersection of 240 and 210; the point (422) of intersection of 250 and 210; the upper right corner (440) of 210; the lower right corner (444) of 210; the lower left corner (432) of 210; the upper left corner (436) of 210; the center corner (428) of 210, the lower left corner (432) of 210; the upper center corner (452) of 210; the top (427) of triangle 220; the lower left base (480) of triangle 220; the lower right base (476) of triangle 220; the upper right corner (456) of rectangle 230; the lower right corner (460) of rectangle 230; the lower left corner (464) of rectangle 230; and the upper left corner (468) of rectangle 230.

Furthermore, the process of obtaining key features may include the classification of those features. Such classification of features may include hard and soft key features, for example. A hard or soft key feature may be distinguished by the likelihood of repeating the location of a key feature, for example, when a fuzzy threshold may be employed. A soft key feature may include a turning point for the boundary of a curved surface, for example. On the other hand, a hard key feature may include an abrupt change in reflectance data at a corner or a particular edge, that is unlikely to be affected much even in the event of a slight variation in the orientation of the feature after an acquisition parameter has changed from one set of reflectance data to another.

Another classification may include “common” and “non-common” features. Common features may be identified if they have similar properties. A common feature may be a key feature present in one data set that directly corresponds to another key feature in another data set, such as the box 110 in FIG. 1 and the box 210 in FIG. 2, the triangle 120 in FIG. 1 and the triangle 220 in FIG. 2.

For each feature in the example in FIG. 3, a common feature may be searched for in the example illustrated in FIG. 4. For example, 372 represents the top of the triangle on the box in FIG. 3 while the acquisition device is at one orientation, and 472 in FIG. 4 represents the top of the same triangle while the acquisition device is at a different orientation. The location in raster coordinates of 372 could then be compared to the raster coordinates of 472 to yield azimuth and polar angles to each common feature. The only unknown quantity that accurately describes the 3D model is the range—or distance—to the feature, if the position and orientation for each acquisition instance are known Likewise, other common features could be related from one data set to the other, and their corresponding range values could be obtained through a numerical inversion technique. Thus, common features would be used to identify similar artifacts that represent the same location on a 3D model that has been captured utilizing varied acquisition parameters such as orientation or position, from which the desired parameters for the 3D model may be obtained.

A non-common feature may be classified as such if, for example, the feature found in one data set does not correspond mathematically identically to another data set that has undergone a simple rotation and translation of the acquisition parameters. The line 160 of intersection of the left and right facing walls in FIG. 1, for example, intersects the top of the data set 100 in a different location than the intersection of line 260 in FIG. 2 and the top edge of data set 200. This is because the exact location that 320 intersects the top of 100 in FIG. 3 is not the identical “key feature” as found in 420 of FIG. 4. The top of the line separating the two walls may extend for an unknown distance above the field of view of the reflective acquisition device. Such a classification and proper handling of the non-common key features can prevent a numerical inversion from converging on the incorrect solution.

Estimating parameters may comprise estimating rotation and translation information that relates acquisition parameters from one set of reflectance data to another set. This may be accomplished by a numerical inversion technique such as, but not limited to: stochastic gradient, conjugate gradient, Newton method, hybrid Newton method, regularized method, steepest descent, stochastic filter, least squares, recursive least squares, or a genetic algorithm. The forward problem used in numerical inversion may include standard graphics algorithms for 3D rotations and translation of objects. The forward problem may further include the mapping of rotated and translated objects to a viewing plane or frustum. The forward problem may further involve pixelating or rasterizing the mapped objects to screen space, according to algorithms that would be apparent to those skilled in the art. The unknown parameters recovered in the numerical inversion may include, without limitation, 3D model geometry, a 3D model texture map, 3D model texture mapping coordinates, the location of the reflectance data acquisition device, the orientation of the reflectance data acquisition device, a light source or plurality of light sources, or other parameter.

The forward problem utilized in performing numerical inversion may involve the rendering equation. The rendering equation can be expressed as:

Lₒ(x,\vec{w})=Lₑ(x,\vec{w})+∫_{Ω}fᵣ(x,\vec{ω}′,\vec{w})Lᵢ(x,\vec{w}′)(\vec{w}′·\vec{n})d\vec{w}′

This equation calculates the outgoing light (Lo) as the sum of emitted light (Le) and reflected light. The reflected light is the sum of incoming light (Li) from all directions, multiplied by the surface reflection and incoming angle. Rendering utilizing the computer graphics techniques may include ray casting, radiosity, ray tracing, texture-mapping, path tracing, distribution ray tracing, bidrectional path tracing, metropolis light transport, or by applying monte carlo methods.

The bidirectional reflectance distribution function is a simple model to describe how light interacts with a surface and can be expressed as:

$${f}_{r} ( x , {\vec{w}}^{′} , \vec{w} ) = \frac{d {L}_{r} ( x , \vec{w} )}{{L}_{i} ( x , {\vec{w}}^{′} ) ( {\vec{w}}^{′} \cdot \vec{n} ) d {\vec{w}}^{′}} .$$

Other forward problems may include a simplified model to describe the interaction of light on a surface such as the Lambertian model of diffuse reflectance,

I_{D}=ρLᵢ·NI_{L}

where I_{L} is the amount of incident light, N is the surface normal vector, Lᵢ is the incident angle of light hitting the surface, ρ is the reflectance, and I_{D} is the amount of light that is reflected; the Oren-Nayar model of diffuse reflectance,

$${I}_{D} = \frac{ρ}{π} cos ( {θ}_{i} ) ( A + B max ( 0 , cos ( {φ}_{i} - {φ}_{r} ) ) sin αtan β ) {I}_{L}$$

$$A = 1 - 0.5 \frac{{σ}^{2}}{{σ}^{2} + 0.33}$$

$$B = 0.45 \frac{{σ}^{2}}{{σ}^{2} + 0.09}$$

where θᵢ, θᵣ, φᵢ, φᵣ represent the vertical incident angle, the vertical reflected angle, the horizontal incident angle, and the horizontal reflected angle, respectively. The surface roughness is σ, and

α=max(θᵢ,θᵣ), and β=min(θᵢ,θᵣ),

or Phong model of specular reflectance, or other. Forward engineering may further be utilized to validate the integrity of the obtained 3D model.

One exemplary embodiment of the specular reflectance model used by the present invention may include the Cook-Torrance model, which is given by

k_{spec}=S(\hat{R}·\hat{V})ⁿ.

The numerical inversion of the Oren Nayar shading model for industrial plant primitives may be performed using the model parameter vector, m, as [S, n, ρ, σ].

The forward operator for the inverse problem may be

A(m)=k_{spec}(S,n)+Lᵣ(ρ,σ).

The inverse problem may iteratively approximate m at each iteration, i, by calculating

mᵢ=−inv(F′F)F′(A(mᵢ₋₁)−d),

where F is the Frechet derivative and d is the data vector.

At least some example embodiments of the present invention may use numerical inversion to determine parameters such as ambient light intensity, diffuse light intensity, specular or emissive light. Any one of several algorithms may be used to determine the properties of a physical object—of which Oren-Nayar, Lambertian, Cook Torrance, Phong, are included, but not comprehensive. Reflective surfaces, shadows, translucent surfaces may all be determined by example embodiments of the present invention.

The numerical inversion methods employed in various embodiments of the present invention may involve an overdetermined, non-unique, or potentially numerically unstable process. Non-uniqueness presents some challenges. At least some embodiments of the present invention may overcome these challenges by utilizing shared information between the plurality of data sets. For example, uniqueness may be attained by constraining the model parameters by utilizing information known a-priori. One exemplary embodiment, for example, may constrain an architectural element such as a ceiling or floor height to a fixed quantity for certain applications, thus limiting the solution space of the numerical inversion process to a solution space in which the parameters may be uniquely determined. Numerically stable systems may be attained by utilizing Tikonov or other regularization techniques.

For instance, in one particular embodiment, multiple unknowns may be present such as: acquisition device location or orientation; range to the 3D model, or other. In such a case, example embodiments of the invention may use a Monte Carlo, Genetic Algorithm or other method to obtain a set of suitable values that relate one obtained quantity to another. Then, one or more of such embodiments may iterate through more data sets and obtain more suitable values that relate one obtained quantity to another, thereby acquiring a complete set of possible combinations of unknown quantities. This process will inherently limit the solution space for future iterations, thereby allowing the valid solution space to converge to a smaller range of values, and in some cases, converge to the single correct quantity for all salient unknowns.

Statistical inference may be utilized by at least some embodiments of the present invention to estimate the maximum likelihood of all possible non-unique outcomes to thereby converge on a particular value for each unknown quantity. This may be accomplished by calculating a histogram for each possible unknown discovered at each point in time. The histogram could then be used to determine the likelihood of an occurrence given a particular set of parameters. The parameter that has the highest likelihood as calculated by the repeated histogram could be selected as the one with the maximum likelihood estimate for the unknown quantity. Numerical instability may be averted by using a regularization or other method known to those skilled in the art of numerical inversion.

B. Example Methods

One method may comprise triangulating a grid where each corner of a pixel in an image may comprise a vertex for a triangular or quad surface. The azimuth and polar angles from the vantage point of the camera or other data acquisition device are known, as is the field of view, if a camera or acquisition system is properly characterized prior to performing the inversion process, with the range value, which may be in polar coordinates, as the only unknown quantity for each pixel. The range value, along with any others, such as the camera or acquisition device origin, camera or acquisition device orientation vector, Oren-Nayar roughness, diffuse reflectance albedo, specular coefficient or exponent, light position, angle, color, and so forth are some (but not exclusive) examples of model parameters that embodiments of the present invention may calculate. The inversion process requires an estimate for the data that are acquired by the camera or acquisition device. The estimate may be attained by employing a forward operator found in a custom graphics engine or a readily available graphics engine such as DirectX, OpenGL, Java, Hoops rendering engine, a gaming engine or other. The estimate is determined by input parameters, then compared with the data vector and the misfit functional is calculated. An update to the model parameters is then calculated and then the process is repeated until the exit criteria are met. Exit criteria may comprise a threshold in deviation in the updated model parameters, the number of iterations, a threshold value for the misfit functional, or other.

For highly reflective surfaces, a surrounding model may be used to determine the environment that is reflected off of the shiny surface. The surrounding model may comprise a textured cylinder, a sphere, a cone or any other geometric configuration.

A plurality of frames may be utilized to determine the unknown model parameters. Boundary refinement of the mesh may be employed at any stage in the inversion process to enhance the 3D model. Any element involved in the inversion process, such as continually dark sections or light sections that would cause numerical instability in the system may be removed prior to numerical inversion to ensure stability. Constrained Delaunay triangulation may be used to enhance a model. Mesh reduction or other model optimization may be employed to enhance a model. The mesh attained by any particular embodiment of the present invention may have geometric elements such as vertices, texture maps, or other that could be optimized for greater performance. Such optimization may include removing redundant vertices, for example, where a single polygon or triangle could be used in the model in place of a plurality of polygons. Likewise, the resolution of a texture map may be reduced where few variations in visual appearance may exist. Other simplifications may be employed, for example, if a primitive geometric shape were discovered in the 3D model. In such a case, an exemplary embodiment of the present invention may characterize the geometric model with minimal primitive parameters, such as a starting point, an extrusion length, a centerline vector and a radius if the primitive were a cylinder; or an exemplary embodiment of the present invention may characterize the geometric model as a center and a radius, in the case of a sphere. Further exemplary embodiments of the present invention may include (without limitation) the reduction of the reflectance parameters from the general Oren Nayar albedo, color and roughness to the Lambertian representation of simply albedo and color, if the roughness parameter were sufficiently small.

One exemplary embodiment of the present invention may include reflectance data that are gotten by an incremental change in acquisition parameters. Such a constraint would impose limitations on the speed of movement of the acquisition device, and thereby limit the amount of unique data within the plurality of data sets. Such a constraint would further reduce the solution space inherent in the numerical inversion process, thus speeding convergence and reducing the likelihood for falsely settling on an erroneous, local minimum in the error function.

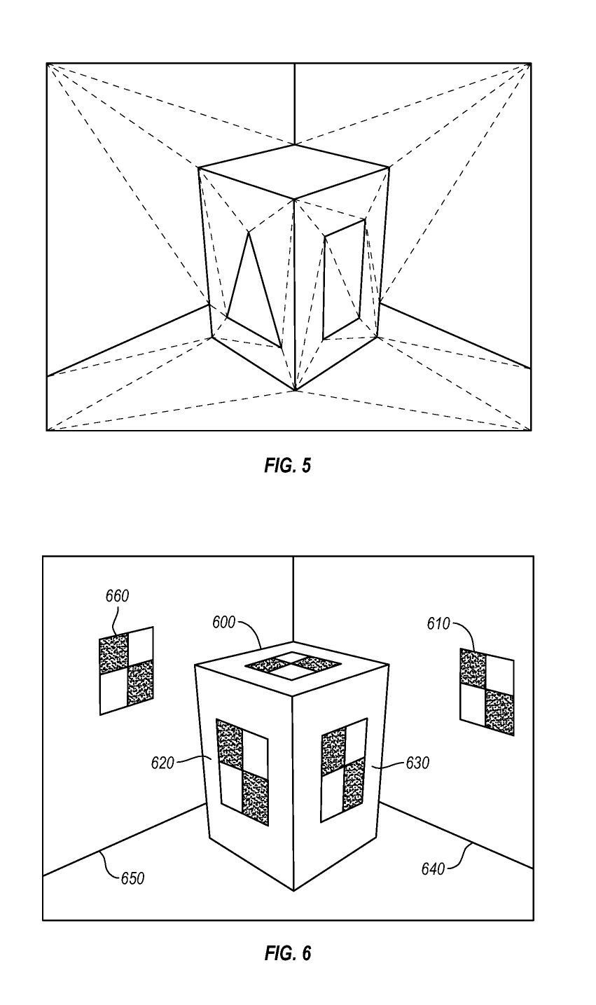

Estimating a parameter may utilize the determining of connectivity between key features. FIG. 5 is an illustration of the connectivity of 110 in FIG. 1. Key features may be points or lines or other entities. In FIG. 5 there are points and lines. The points in this particular embodiment are on the corners or points of intersection of lines. When connecting the key features, the points may be utilized as vertices and the lines may be utilized as “break-lines” where no triangle edge can cross. Creating a triangulated model as shown in FIG. 5 may be accomplished by utilizing a Constrained Delaunay triangulation technique, or other geometric modeling tool known to those skilled in the art. The connectivity may be updated based on the incremental change in acquisition parameters. If a unique key feature appears in a data set, the connectivity may need to be re-established. Establishing connectivity between all pixels, and obtaining parameters for all pixels may also be utilized to determine parameters for a 3D model. Or an interpolation technique such as spline, cubic, linear, quadratic, sinc, or other may be employed to determine the geometry of indistinguishable regions.

There may be circumstances wherein the desired unknown parameters include an object or plurality of objects that appear as reflections on highly reflective surfaces within the data set. The object or objects may include a light source, geometry pertaining to a reflected object, and reflectance information pertaining to a reflected object.

The present invention may further utilize a global positioning device, an inertial measurement device, a known reflectance data acquisition position, a known reflectance data acquisition orientation, a defined path for reflectance data acquisition, a defined orientation for reflectance data acquisition, the location of a known target within the view of the reflectance data acquisition device.

Estimating parameters that characterize a 3D model may also be accomplished by estimating parameters that characterize an object from a known library of objects. For example, FIG. 6 illustrates a scene with targets that are utilized from a known library of objects. The targets 600, 610, 620, 630 and 660 are placed on 3D surfaces that are desired to be characterized. The target is identified in the scene, whether automatically or otherwise, and then the orientation and position parameters for each target are determined. Numerical inversion, as disclosed herein, may be used to determine the parameters. Likewise, it will be apparent to those of ordinary skill in the art that other optimization techniques may also be utilized. Once the target parameters have been determined, a planar surface may be generated, and the intersection of the planar surfaces may be used to determine the full shape of each flat surface. Additional targets may be placed, but are not shown in FIG. 6, to correctly extract the flat horizontal surface on which the other objects intersect. The walls on which targets 660 and 610 reside intersect the flat horizontal surface along the lines shown as 650, and 640 respectively.

Likewise, a circular surface such as a columnar pillar, for example, may be characterized by utilizing targets of a known size and pattern from a library that are then attached to the circular surface. The center of each target, for example, may be determined from by embodiments of the present invention, and then a cylinder extraction technique, such as Levenburg Marqhaurdt, for example, may be utilized to quantify the correct parameters for the cylinder. Virtually any object may be extracted by embodiments of the present invention through the use of library objects.

Estimating parameters that characterize a 3D model may also include determining a code associated with the object characterized from a known library of objects. Some examples of a particular coding technique that may be used include, without limitation, bar code, QR code, pseudo Noise code, binary sequence, KW-37, cryptography, polymorphic code, cipher suite, LK-7, palcrypt, BATCO, authenticated encryption, ring code, OPS-301, A5/1, Tiny Encryption Algorithm, or GSM.Codes may be utilized that are simply alphanumeric, or characters in a foreign language, or image based. Pattern and character recognition algorithms, which will be apparent to those skilled in the art, may then be used to automatically determine the code for each library object found in a data set.

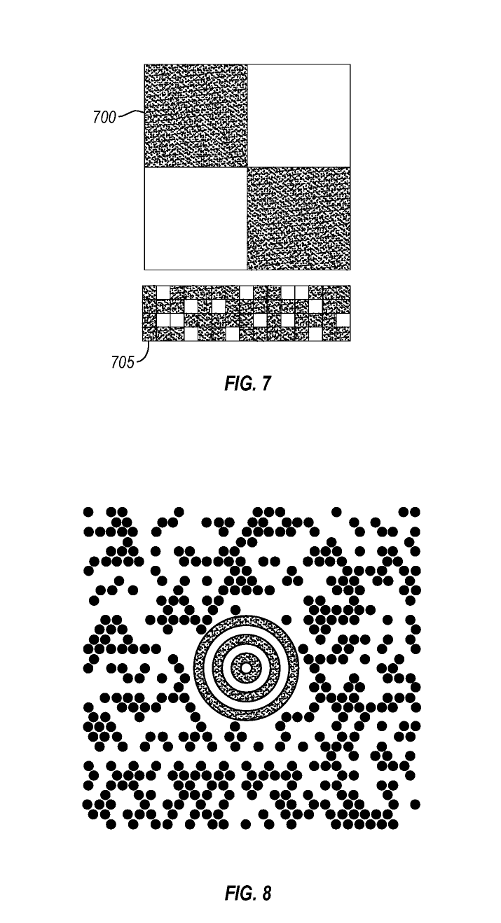

FIG. 7 shows a known library object that utilizes a pattern, 700, which may be used primarily for orientation and distance determination, with a pattern below, 705, which may be used to provide annotation information about a target. The annotation information on the target may be utilized to efficiently acquire detailed information about the object on which the target resides, which may then be included in the 3D model for future reference. Such annotation information may be useful in creating a Building Information Model (BIM) or any 3D model that benefits from added information, such as for a command and control center for security, emergency response, emergency response training, or other utilization.

B. Some Alternate Systems and Methods

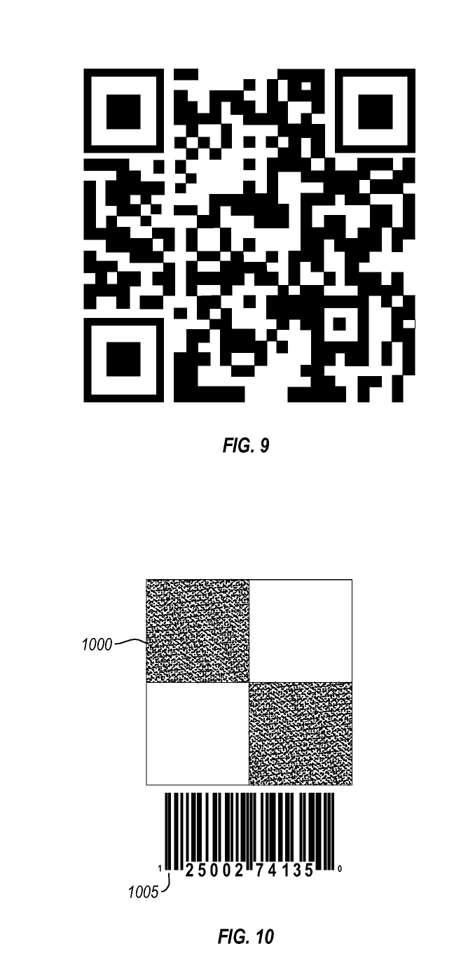

FIG. 8 and FIG. 9 show alternate systems and methods that may be utilized, without limitation, in the present invention. FIG. 8 discloses an example embodiment of a coding scheme that may be utilized to determine the orientation, scale, or an architectural or other property of the object to be modeled. The center target of FIG. 8 may be used to automatically detect scale and orientation of the code shown. The image shown in FIG. 9 may offer error correction techniques as well as ease of automated identification and scale. The three large enclosed, concentric squares on the bottom left, upper left and upper right of FIG. 9 allow an automated recognition method key features for determining orientation and scale for this particular code. FIG. 10 illustrates a pattern, 1000, that may be used primarily to determine orientation and distance information, and a pattern, 1005 that may be used for encrypting annotation information.

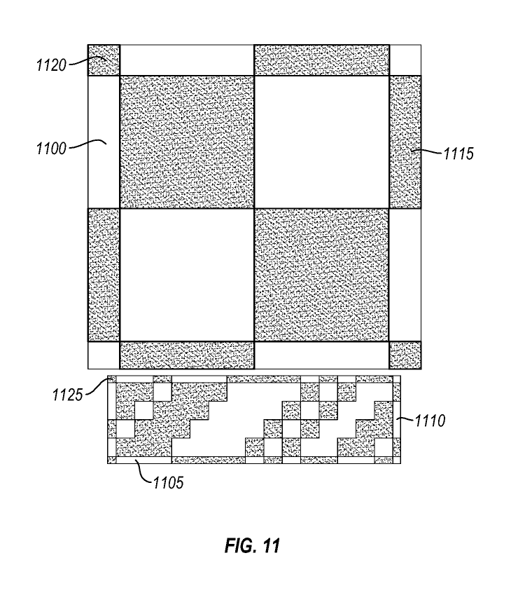

FIG. 11 also illustrates another exemplary embodiment of the present invention. 1100 signifies a large black square that may be useful in determining orientation and position of the library object in the scene. Other patterns such as those shown as 1115 and 1120 may be useful in assisting corner detection algorithms for determining orientation and distance. A code pattern is shown below the larger pattern defined by 1100, 1115, and 1120, among other large objects. Pseudo noise codes such as Maximum Length codes may be utilized to encrypted numerical information, which then correspond to pre-determined annotation information for each target. The pattern shown in FIG. 11 has four rows and fifteen columns. The rows may signify words, while the columns may signify bits in a word. The code pattern is then surrounded by shapes, of which 1125 is an exemplary embodiment, as seen in 1115 and 1120 to assist in corner detection. 1105 is the lower left bit that may be utilized as the most significant bit in the word found in the fourth, or bottom row. The third row has a least significant bit 1110, as shown on the right. The shift or offset of the codes may signify a character in a hexadecimal string, which then corresponds to a particular type of object, such as a wall, floor, ceiling, window, door, or other predetermined characterization.

Codes may also simply correspond to a target number, so that objects in one data set or photograph may be registered to co-align with objects in another data set. Codes may also utilize error correction techniques to ensure robust characterization of the proper encrypted alpha numeric string.

Encoded targets may also provide geometric information as well, such as a pre-determined target with a specific code may be known to exist at a particular edge, so that the extrusion of the geometry does not exceed the limits of one or more edge of the target. Such definitions may be particularly useful to characterize edges, such as of doors or windows for example. Furthermore, such edge definitions may be useful to characterize edges of other physical objects, particularly where an intersection with another identifiable object does not exist, or is not easily determined.

Example embodiments of the present invention may also be utilized in conjunction with a monochromatic background to isolate a single object or set of objects from surrounding objects. If a raster containing a particular color is found in the scene, the present invention may choose to remove that datum from consideration to speed up computing time and computational complexity.

Example embodiments of the present invention may create an architectural 3D model by using target points for architectural features as seen on an angular sensing device display screen. The target points obtained pertain to key features in architecture that can be recognized and recorded. The identifiable points in reflectance data can be seen on the screen of the angular sensing device. Obtaining the key features may also comprise receiving input from a user. Acquired reflectance data may be displayed on a computer screen, where a user may manually identify key features such as the intersection of a wall and the floor, or a wall and the ceiling, from which parameters for an architectural 3D model may be obtained, and the values for the parameters may then be determined.

C. Example Objects and Modeling

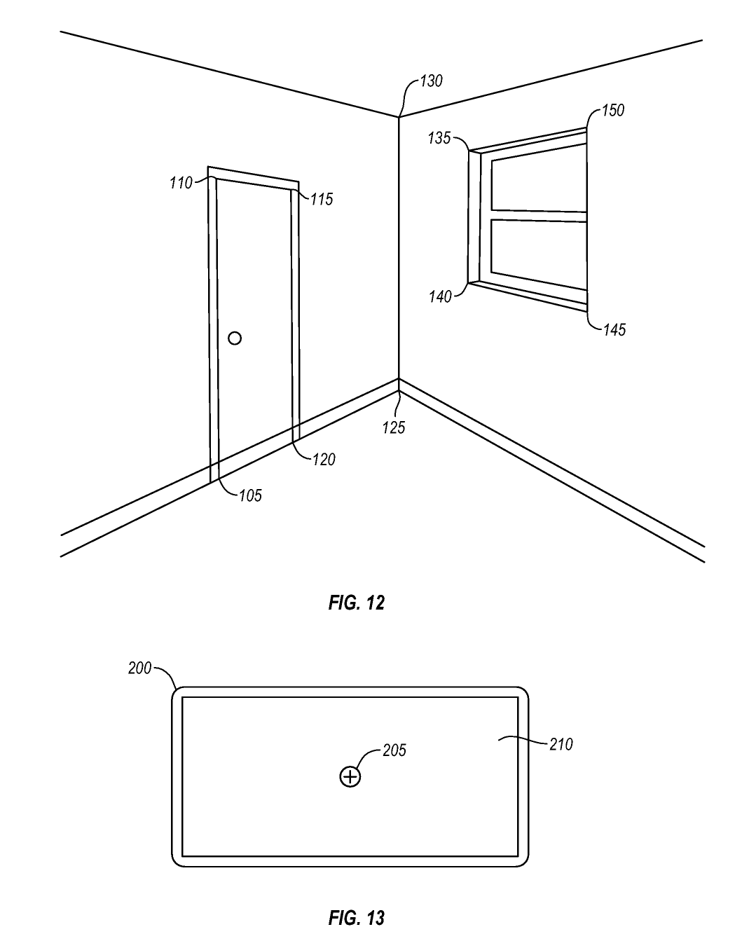

FIG. 12 illustrates a portion of a room that may be modeled using the present invention. Possible key targets in the scene have been identified. The corners of a door are marked: the lower left corner 105, the upper left corner 110, the upper right corner 115, and the lower right corner 120. A floor corner intersection with two walls 125 is shown. A ceiling corner intersection with two walls 130 is shown. The four corners of a window are shown: upper left corner 135, lower left corner 140, lower right corner 145, and upper right corner 150.

FIG. 13 shows a possible exemplary embodiment of an angular sensing device 200 that may be used in present invention. The angular sensing device may utilize a display screen 210 to interface with the user. The display screen may employ a central identifier 205 to precisely locate the key feature in architecture.

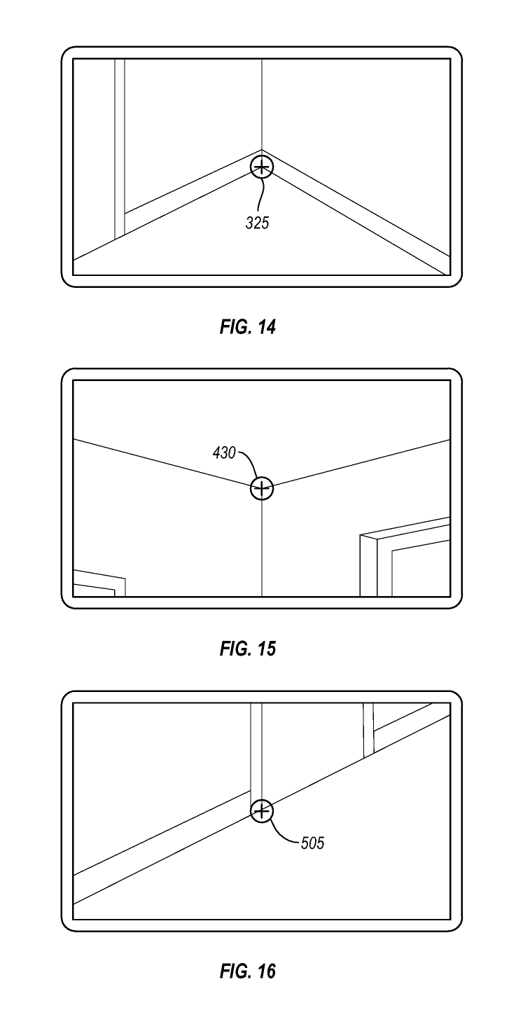

FIG. 14 illustrates aspects of an example embodiment of the present invention where a user centers a key feature 325, in this case a floor corner intersection with two walls, over the display screen. The corner may be identified as such on the angular sensing device when the key feature is centered over the central identifier 205. Other corner intersections of walls and the ceiling may be identified by a user using the angular sensing device, as shown in FIG. 15, where the intersection 430 is shown.

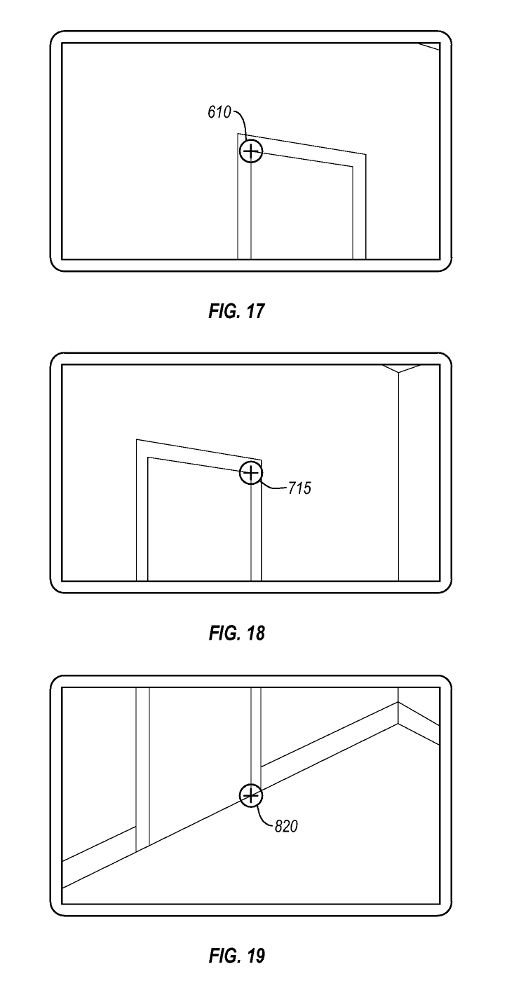

A door may be identified by its four corners, 105, 110, 115, and 120. FIG. 16 illustrates the identification of the lower left corner 505 of a door. FIG. 17 shows the upper left corner 610. FIG. 18 shows the upper right corner 715. And FIG. 19 shows the lower right corner 820.

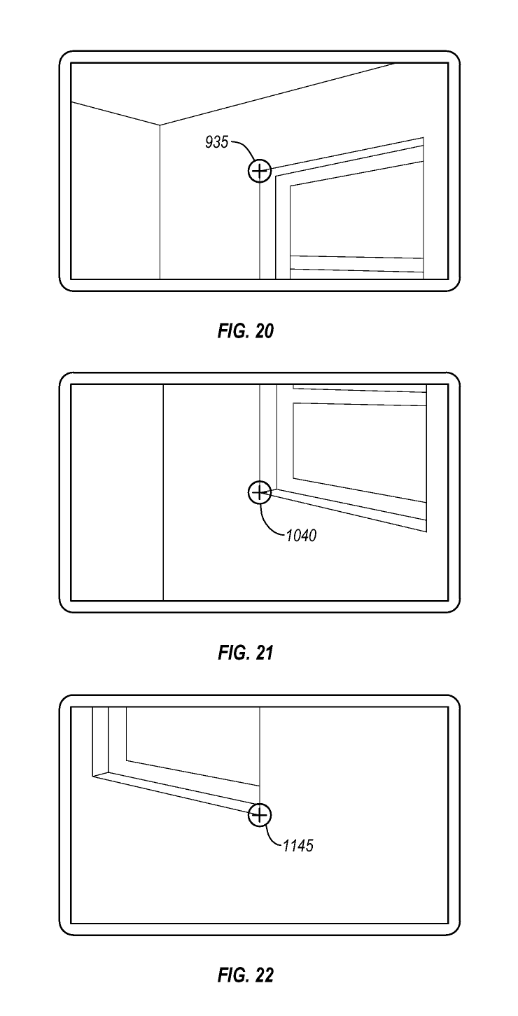

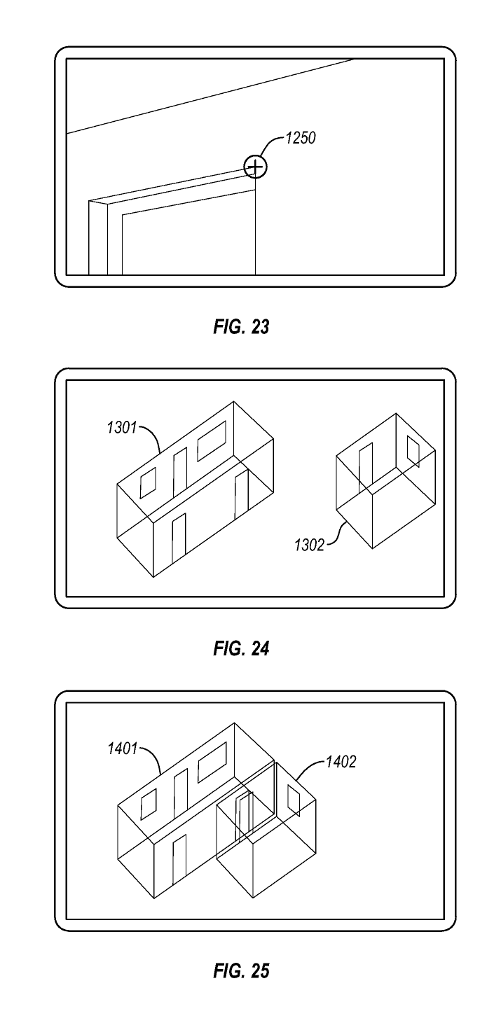

Likewise, a window may be modeled by centering its four corners 135, 140, 145, 150 over the central identifier of the angular sensing device. FIG. 20 shows the upper left corner 935 centered. FIG. 21 shows the lower left corner 1040. FIG. 22 shows the lower right corner 1145. FIG. 23 shows the upper right corner 1250.

In at least some embodiments, user input to alter wall coloring, texture, sheen, or other property may be utilized. The user may also change lighting (a light fixture, light bulb type, or other), floor covering (tile, carpet, hardwood, or other), add lights, remove a wall, insert a closet, add a feature from a library of architectural objects such as an archway, a pillar, or other. The scene may be rendered from a specified point, or the user may be allowed to walk through the room, and pan, rotate, or use another mechanism to alter the vantage point.

The user may elect to insert furniture, artwork or other furnishings into the scene and the scene may be rendered with any variety of 3D graphics rendering schemes including, but not limited to shadows, specular highlights, diffuse reflectance, or other. The scene may be rendered to a cloud, server, or other processor if the viewing device is determined to be of insufficient processing power to adequately render the scene in a timely or accurate manner. Such a case requires a plurality of parameters to be sent to the alternate processor or processors such as the camera viewpoint, the lighting sources, the texture information for the 3D model, or other pertinent information for the scene to be rendered. The resultant image or model may be then transmitted back to the viewing device to be displayed to the user.

Embodiments of the present invention may permit a user to add features to a model, or select or alter a particular aspect of the model. The window type, for example may be selectable by the user. The crown or base molding type, height, flute, or color; door type, light type, other. A menu bar, or other mechanism, may allow the user to select the alterations or additions.

Embodiments of the present invention may operate to further obtain information about the room such as photographic information from which wall color, texture, sheen or other may be automatically determined or determined with user input. Other features may be determined as well, such as floor type, color, lighting type or other. Embodiments may automatically select the base or crown mold, window woodwork, lighting, or other based on the image provided. Data from one image may be applied to data from another image.

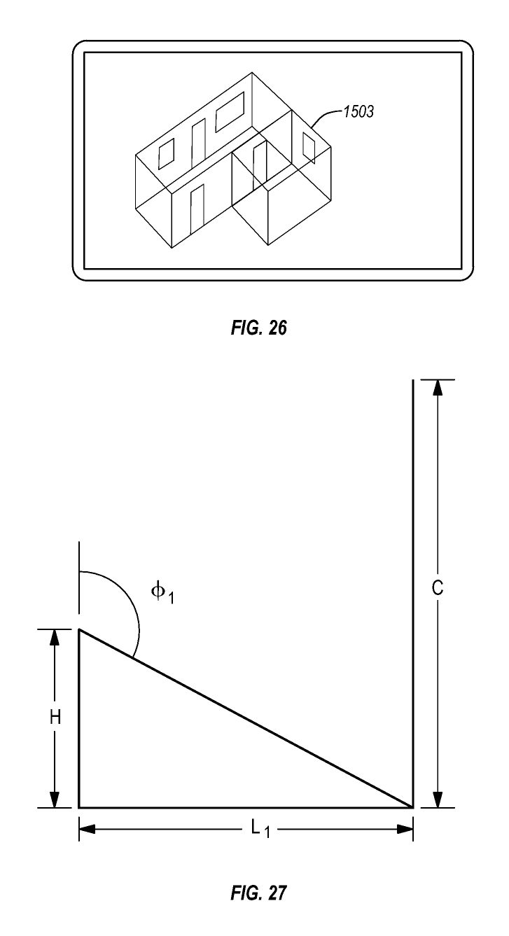

Disparate information from one room may be used to complete the 3D model of a room, and subsequently, models of multiple rooms may be combined to form a 3D model of a house, building, office, or other. FIG. 24 shows two disparate rooms that have been modeled using the present invention. The model on the left 1301 adjoins the model to the right 1302 at a common doorway. The user may drag one model to align with another on the display screen of the angular sensing device as shown in FIG. 25. The left model 1401 is brought close to the right model 1402 (or vice versa) by dragging a finger across the touch screen of the angular sensing device until they are almost overlapping, for example. When closely aligned the present invention may elect to automatically adjust the lengths of walls so that the objects fit exactly in the model. FIG. 26 shows the adjoined model 1503.

Other annotation information, such as wall material type, examples of which may include drywall, plaster, and brick, or wall thickness or other attribute may be provided by the user or automatically determined to enhance the model.

Certain parameters for creating the 3D model may be obtained by the angular sensing device, and then processed. FIG. 27 shows one such set of parameters. The angle measurements are shown in spherical coordinates, but may be represented or utilized in any coordinate system. The distance from the acquisition point L1 to the corner of a wall, may be obtained by utilizing the ceiling height C, and the polar angle to the corner φ₁ that is obtained from the angular sensing device. FIG. 28 shows another configuration where the user obtains the angle h2 by aiming the angular sensing device to be centered over the corner intersection of the walls and ceiling. The horizontal distance L1, the ceiling height C and the acquisition height H are the same as in FIG. 27, Angle φ2 given by the angular sensing device, or other, can be used with other known quantities to calculate the unknown parameters, using trigonometric identities, algebraic, or other methods.

$$tan {φ}_{2} = \frac{C - H}{{L}_{1}}$$

$$tan ( π - {φ}_{1} ) = \frac{{L}_{1}}{H}$$

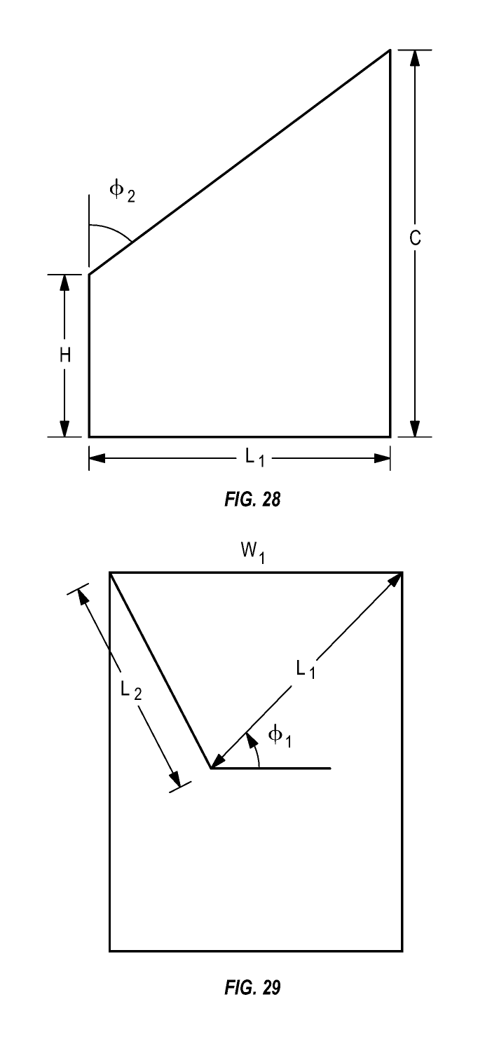

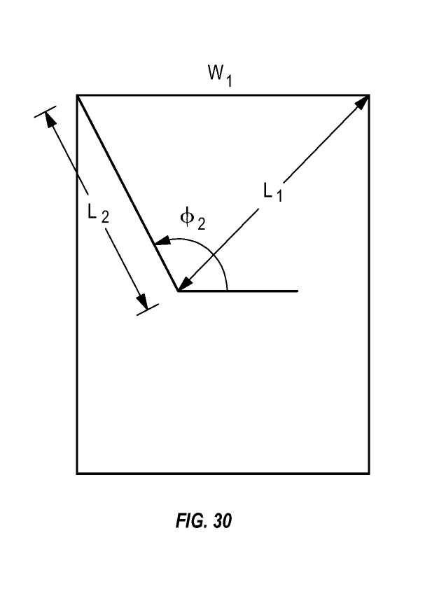

Other horizontal distances to other key features may be determined in a similar manner. FIG. 29 shows a top down view of a room where the distance to the upper right corner L1 of the room and the upper left corner L2 of the room from the acquisition point are also shown. The azimuth angle θ₁ is shown in FIG. 29 as the angle between a horizontal reference angle, as determined by the angular sensing device (due East in FIG. 29, if North is up). FIG. 30 shows a second azimuth angle θ₂ between the horizontal reference angle and the second corner along L2. L1, L2, θ₁, and θ₂ may be used in conjunction with any other known quantity to determine the length of a wall W1, for example, or any other unknown quantity. The horizontal distance L1 in FIG. 27 and FIG. 28 is the same value in FIG. 29 and FIG. 30, they are just shown from different vantage points.

Computer hardware components are presently created to increase performance of implementing the forward operations listed herein. Many of the functions that are utilized in the present invention are precisely those that are implemented in GPU hardware for rendering 3D models in real time. Thus the present invention may utilize a local graphics processing unit (GPU) to perform the estimating parameters function. Presently computer systems with a plurality of GPUs are being developed; thus, estimating parameters according to the present invention may select two or more of a plurality of local GPUs to be operated in parallel during the act of operating to enhance computing performance. Furthermore, massively parallel hardware have been created to perform the forward modeling problems listed herein; thus the present invention may be employed to operate a plurality of computer or central processing units (CPU) to perform the estimating parameters function.

While some example computer hardware and software systems are discussed in more detail elsewhere herein, it should be noted that computer hardware components may be configured consistent with the disclosure herein for the performance of implementing the forward operations listed herein. Many of the functions that are utilized in the present invention may be implemented, for example, in GPU hardware for rendering 3D models in real time. The forward operators of the inversion process that utilize a 3D graphics rendering engine such as DirectX, OpenGL, UnrealSDK, or other, are best run on GPU hardware. Mesh reduction, image processing, utilizing the Lambertian, Oren Nayar, Cook Torrance reflectance models or other shading or rendering techniques are well suited to run on GPU hardware. Thus, a local graphics processing unit (GPU) may be used to perform the estimating parameters function disclosed herein. Computer systems with a plurality of GPUs may be used. Accordingly, estimating parameters according to example embodiments of the present invention may involve the use of two or more of a plurality of local GPUs to be operated in parallel during the act of operating to enhance computing performance. It is to be understood that any configuration of parallel computing may be used to perform the forward modeling problems listed herein. Some examples of parallel computing may include (without limitation) multicore computing where multiple cores reside on the same chip; symmetric multiprocessing where a computer system contains identical processors that share memory and connect through a data bus; distributed computing is a memory computer system where processing elements are connected by a network; a computer cluster where loosely coupled computers work closely together; massive parallel processing wherein a the interconnection of networks utilizes specialized hardware for connectivity; grid computing where computers are connected over the internet; specialized parallel computers such as those configured with field programmable gate arrays (FPGAs), general purpose graphics processing units (GPGPUs), application specific integrated circuits (ASICs), or other processors.

There may be circumstances wherein the desired unknown parameters include an object or plurality of objects that appear as reflections on highly reflective surfaces within the data set. The object or objects may include a light source, geometry pertaining to a reflected object, and reflectance information pertaining to a reflected object.

At least some embodiments of the invention may involve the use of one or more of a global positioning device, an inertial measurement device, a known reflectance data acquisition position, a known reflectance data acquisition orientation, a defined path for reflectance data acquisition, a defined orientation for reflectance data acquisition, and the location of a known target within the view of the reflectance data acquisition device. In some instances, global positioning information can be obtained using devices such as notepads and tablet devices. If a global positioning device were utilized at the time of reflectance data acquisition, the resultant 3D model may be positioned and/or oriented in global coordinates, thus determining the location of the model in the real world. The model may then be rendered, viewed, altered or otherwise utilized in a program that utilizes global coordinates such as a CAD program, Google Earth, Microsoft Live, or other.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention. Furthermore, the systems and methods represented herein may comprise a program storage device, a computer, hardware, software, FPGA, ASIC, ROM, or other device or element.

D. Example Method

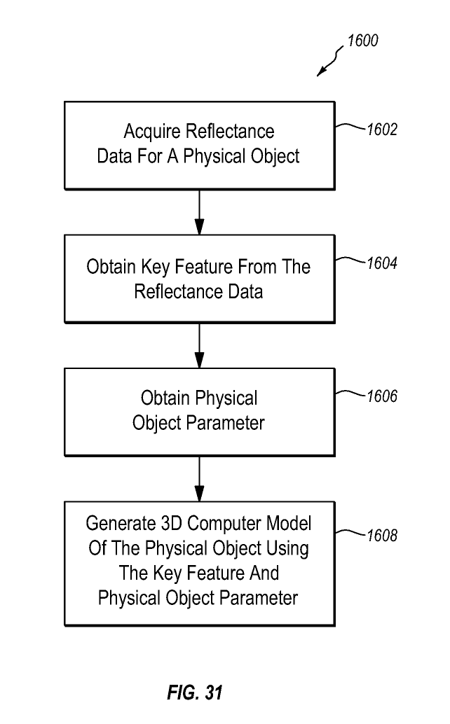

With attention now to FIG. 31, details are provided concerning an example method 1600 for generating a 3D computer model of one or more physical objects based on reflectance data obtained from the one or more physical objects. As noted elsewhere herein, one particular type of reflectance data is specular reflectance data, however the scope of the invention is not limited to any particular type(s) of reflectance data. At 1602, data relating to a physical object, such as reflectance data for example, is acquired. As disclosed elsewhere herein, any of a variety of devices, or combinations of devices, may be used to acquire such data. The acquired data may be stored in a database or file system such as are discussed below, although that is not necessary.

Once the reflectance data has been acquired, one or more key features may be obtained 1604, by any of the methods disclosed herein, from the reflectance data. One or more physical object parameters, examples of which are disclosed herein, may be obtained 1606. Finally, a 3D computer model, or portion thereof, of a physical object is generated 1608 using the key feature(s) and the physical object parameter(s).

Once generated, the 3D model can be stored, and user versions of the 3D model may be derived from the 3D model and stored as well. A user version of the 3D model can be accessed, such as by a client 1702 over a network for example. In some instances, the user can access the user version of the 3D model by way of a website accessible from the client 1702. The user version of the 3D model may have user-modifiable attributes such that the user version of the model can be customized, to a predefined extent, and saved by the user without affecting the integrity of the underlying 3D model. To illustrate, a 3D model of a house can include a user-modifiable attribute such as flooring so that a user can change the flooring to tile and save the changed version locally, or on a web server, without disturbing the integrity of the 3D model itself. A user at the client 1702, and/or elsewhere, can manipulate the user version of the 3D model and generate and print different views of the user version of the 3D model, if desired. The user may also be able to save particular views of the user-customized 3D model on a local computer, and/or on a server accessible by way of a network, so that the user can later access and modify those views.

E. Example Computing Environments

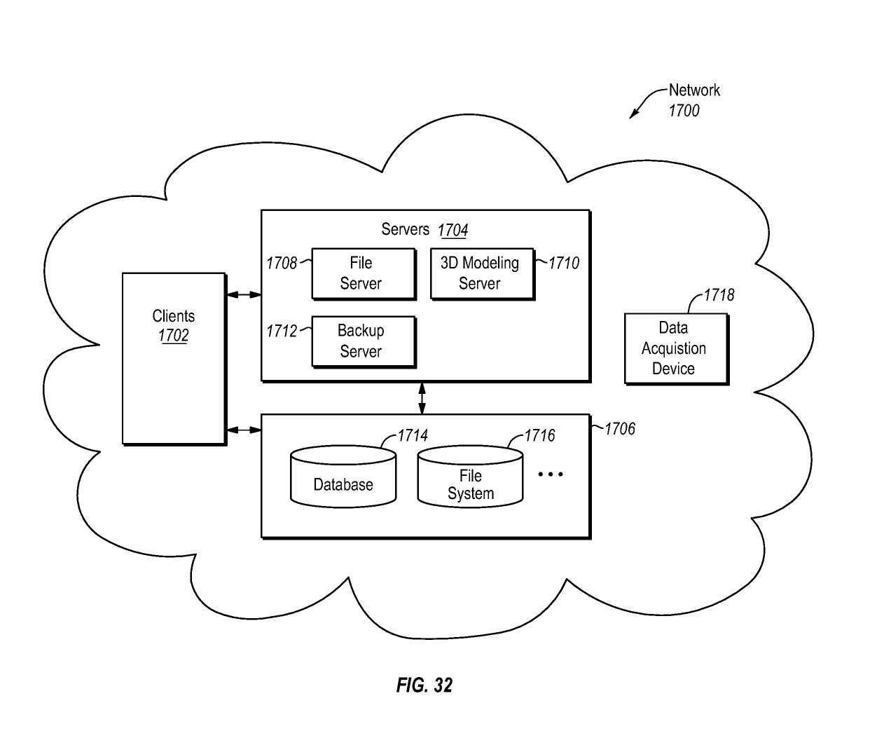

FIG. 32 illustrates an example of a network environment in which at least some embodiments of the invention may be employed. In the example of FIG. 32, the system 1700 represents a network such as a local area network, a wide area network, and the like, or any combination thereof. The connections in the network 1700 can be wired and/or wireless. In this case, the network 1700 typically includes one or more clients 1702 that have access to various servers 1704 and to data 1706. Various services are typically provided by the servers 1704 and, in some embodiments, access to some or all of the data 1706 is controlled by the various servers 1704. Some of the data 1706, such as backed up data for example, is not necessarily available to the clients 1702.

Examples of the servers 1704 may include a file server 1708, a 3D modeling server 1710, a backup server 1712, or any combination thereof. Each of the servers 1704 resides in or is accessible over the network 1700, and the servers 1704 may or may not be co-located. The data 1706 may include, among other things, a database 1714 and file storage 1716. The file storage 1716 and database 1714 can be implemented in various ways using different software, different configurations, and the like. In some instances, the file storage 1716 and/or database 1714 may include a library of 3D models, which may be accessible by a client 1702, and can be in various stages of completion, from newly begun to completed.

Software for executing one, some, or all of the methods disclosed herein may reside on 3D modeling server 1710. The 3D modeling server 1710 may comprise one or more GPUs. As well, the 3D modeling server 1710 may include processors, memory, storage and various other components, as discussed in more detail herein, that can be employed in any or all aspects of the 3D modeling processes disclosed herein.

In at least some instances, the 3D modeling software may be accessed and operated by way of a client 1702. Further, information from data acquisition devices 1718, examples of which are disclosed herein, can be provided to one or more of the servers 1704 and data storage 1706. The transfer of information from the data acquisition devices 1708 can be accomplished wirelessly, by hardwire connection, or a combination of both. The data acquisition devices 1708 may, but need not, comprise an element of the network 1700.

One of skill in the art can appreciate that one or more of the clients 1702, servers 1704, data 1706, file servers 1708, 3D modeling servers 1710, backup servers 1712, databases 1714, and file storage 1716 can be connected in a wide variety of configurations using various types of connections. To illustrate, backup server 1712 may be implemented as a network server from which database backups can be initiated. Further, the software that operates on the servers 1704, clients 1702, and on the data 1706 in some instances, may have certain properties or configurations, as discussed in more detail herein.

F. Example Computing Devices and Media

The embodiments described herein may include the use of a special purpose or general-purpose computer including various computer hardware or software modules, as discussed in greater detail below. Among other things, any of such computers may include a processor and/or other components that are programmed and operable to execute, and/or cause the execution of, various instructions, such as the computer-executable instructions discussed below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system, for example, as separate threads.

While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of generating a 3D electronic model of one or more physical objects, the method comprising;
obtaining reflectance data associated with a physical object;
obtaining key features from within the reflectance data;
utilizing the key features to obtain a model parameter or plurality of model parameters;
estimating the value of a model parameter or plurality of model parameters that characterize a 3D electronic model of the physical object.

2. The method of claim 1, wherein obtaining key features comprises:
using a target in a scene associated with the reflectance data to derive the key features, wherein the target has one or more known attributes.

3. The method of claim 1, wherein obtaining the key features comprises:
receiving input from a user identifying the key features.

4. The method of claim 1, wherein obtaining the key features comprises:
automatically detecting identical key features found in a plurality of sets of reflectance data.

5. The method of claim 1, wherein obtaining key features comprises utilizing an angular sensing device to estimate the key feature's polar and azimuth angles in spherical coordinates at which the acquisition event occurred,

6. The method of claim 1, further comprising using numerical inversion to estimate the parameter that characterizes the 3D electronic model.

7. The method of claim 1, wherein the parameter comprises one or more of ambient, specular, and diffuse material properties of the 3D electronic model.

8. The method of claim 1, wherein the parameter comprises a texture map of the 3D electronic model.

9. The method of claim 1, wherein the parameter comprises an attribute that is associated with a physical object and that complements the 3D electronic model.

10. The method of claim 1, wherein estimating the parameter is performed utilizing a parallel architecture.

11. The method of claim 1, wherein the key features obtained comprise an artifact or plurality of artifacts obtained by an image processing technique.

12. The method of claim 4, wherein estimating the parameter comprises estimating rotation and translation information that relates acquisition parameters from one set of reflectance data to another.

13. The method of claim 6, wherein performing numerical inversion comprises performing one of the following processes: stochastic gradient; conjugate gradient; Newton method; regularized method; steepest descent; stochastic filter; least squares; recursive least squares; and, genetic algorithm.

14. The method of claim 6, wherein the reflectance data are obtained by making an incremental change to the acquisition parameters.

15. The method of claim 6, wherein estimating the parameter comprises determining connectivity between key features.

16. The method of claim 14, wherein determining the connectivity between key features comprises updating connectivity based on an incremental change in acquisition parameters.

17. The method of claim 1, wherein estimating the parameters comprises:
establishing connectivity between all pixels; and
obtaining parameters for all pixels.

18. The method of claim 9, wherein estimating parameters is performed by a local graphics processing unit (GPU).

19. The method of claim 9, wherein estimating parameters is performed by two or more of a plurality of local GPUs operated in parallel.

20. The method of claim 9 wherein estimating parameters comprises operating a plurality of computer or central processing units (CPU) to perform the estimating parameters function.

21. The method of claim 1, wherein estimating parameters comprises:
calculating a set of possible corresponding unknowns in a non-unique inversion; calculating a histogram of corresponding unknowns; and
estimating the maximum likelihood of unknown parameters.

22. The method of claim 1, wherein estimating the parameter comprises utilizing a known quantity for reflectance around the physical object or a set of physical objects to facilitate management of computational complexity when obtaining the parameters for the 3D model of a physical object.

23. The method of claim 1, wherein estimating the parameter comprises estimating a virtual model for reflections on highly reflective surfaces comprising at least one of: a light source; geometry pertaining to a reflected object; and, reflectance information pertaining to a reflected object.

24. The method of claim 1, wherein estimating the parameter comprises utilizing a forward ray tracing model to simulate at least one of: ambient reflectance; diffuse reflectance; specular reflectance; object geometry; and, object texture.

25. The method of claim 1, further comprising utilizing one of the following to obtain the reflectance data: a global positioning device; an inertial measurement device; a known reflectance data acquisition position; a known reflectance data acquisition orientation; a defined path for reflectance data acquisition; a defined orientation for reflectance data acquisition; and, the location of a known target within the view of the reflectance data acquisition device.

26. The method of claim 1, wherein estimating the parameter that characterizes a 3D model comprises estimating parameters that characterize an object from a known library of objects.

27. The method of claim 26, wherein estimating parameters that characterize a 3D model further comprises determining a code associated with the object characterized from a known library of objects.

28. The method of claim 27 wherein the code comprises at least one of: bar code; QR code; pseudo Noise code; binary sequence; KW-37; cryptography; polymorphic code; cipher suite; LK-7; palcrypt; BATCO; authenticated encryption; ring code; OPS-301; A5/1; Tiny Encryption Algorithm; or, GSM.

29. The method of claim 1, wherein the reflectance data is specular reflectance data.

30. A computer-readable medium including instructions that, when executed, cause a processor to perform the following method:
obtaining reflectance data associated with a physical object;
obtaining a key feature from within the reflectance data; and
estimating a value of a parameter that characterizes a 3D electronic model of the physical object.

31. A computing device, comprising:
a processor; and
a computer-readable medium including instructions that, when executed, cause the processor to perform the following method:
obtaining reflectance data associated with a physical object;
obtaining a key feature from the reflectance data; and
estimating a value of a parameter that characterizes a 3D electronic model of the physical object.
